(19) United States
(12) Patent Application Publication
(10) Pub. No.: US 2015/0012723 A1
(43) Pub. Date: Jan. 8, 2015

(54) PROCESSOR USING MINI-CORES

(71) Applicant: SAMSUNG ELECTRONICS CO., LTD., Suwon-si (KR)

(72) Inventors: Young Hwan PARK, Yongin-si (KR); Keshava PRASAD, Suwon-si (KR); Ho YANG, Hwaseong-si (KR); Yeon Bok LEE, Seoul (KR)

(73) Assignee: SAMSUNG ELECTRONICS CO., LTD., Suwon-si (KR)

(21) Appl. No.: 14/324,302

(22) Filed: Jul. 7, 2014

(30) Foreign Application Priority Data
Jul. 4, 2013 (KR) 10-2013-0078310

(51) Int. Cl. G06F 15/76

(52) U.S. Cl. CPC G06F 15/76
USPC 712/3

(57) ABSTRACT

A mini-core and a processor using such a mini-core are provided in which functional units of the mini-core are divided into a scalar domain processor and a vector domain processor. The processor includes at least one such mini-core, and all or a portion of functional units from among the functional units of the mini-core operate based on an operation mode.

### CROSS-REFERENCE TO RELATED APPLICATIONS

This application claims the benefit under 35 USC 119(a) of Korean Patent Application No. 10-2013-0078310 filed on Jul. 4, 2013, in the Korean Intellectual Property Office, the entire disclosure of which is incorporated herein by reference for all purposes.

### BACKGROUND

1. Field

The following description relates to a processor. The following description also relates to a processor using a mini-core.

2. Description of Related Art

A processor in a very long instruction word (VLIW) structure or a coarse-grained reconfigurable array (CGRA) structure may use multiple functional units (FUs). The FUs may be linked together in a chain or series by a data path.

In a configuration of the FUs and the data path in the processor, a large number of combinations of the FUs and the data path available may be possible. For a design with maximum functionality, all FUs in the processor may be configured to process all possible instruction words, and data paths may be configured to link together all FUs. A bit-width processor of a data path may be a greatest potential bit-area from among potential vector data types provided.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a mini-core includes a scalar domain processor configured to process scalar data, a vector domain processor configured to process vector data, and a pack/unpack functional unit (FU) configured to be shared by the scalar domain processor and the vector domain processor, and to process a conversion of data to be transmitted between the scalar domain processor and the vector domain processor.

The scalar domain processor may include a scalar FU configured to process scalar data.

The pack/unpack FU may be configured to convert multiple instances of scalar data to an instance of vector data, and to generate an instance of scalar data by extracting an element at a predetermined position of the vector data.

The vector domain processor may include a vector load (LD)/store (ST) FU configured to process loading and storing of vector data, and a vector FU configured to process the vector data.

The vector domain processor may include vector FUs and the vector domain processor may operate by interconnecting the vector FUs to process vector data of a longer bit length than a bit-length processable by the vector FUs individually.

The vector domain processor may further include a vector memory configured to store the vector data.

The mini-core may transmit the scalar data to another mini-core via a scalar data channel, and the mini-core may transmit the vector data to the other mini-core via a vector data channel.

In another general aspect, a mini-core includes vector functional units (FUs) configured to process a calculation of vector data, wherein the vector FUs operate by being interconnected to one another to process vector data of a longer bit-length than a bit-length processable by the vector FUs individually.

The mini-core may further include a scalar domain processor configured to process scalar data, a vector domain processor configured to process vector data, and a pack/unpack functional unit (FU) configured to be shared by the scalar domain processor and the vector domain processor, and to process a conversion of data to be transmitted between the scalar domain processor and the vector domain processor, wherein the vector domain processor includes the vector FUs.

In another general aspect, a processor includes a mini-core, wherein the mini-core includes a scalar domain processor configured to process scalar data, a vector domain processor configured to process vector data, and a pack/unpack functional unit (FU) configured to process a conversion of data to be transmitted between the scalar domain processor and the vector domain processor.

The processor may be configured to halt an operation of the mini-core, based on an amount of calculation to be processed by the processor.

The processor may be configured to halt an operation of the mini-core by blocking a clock provided to the mini-core, or by blocking power to the mini-core.

The processor may be configured to assign the mini-core to threads, and to simultaneously execute the threads.

The processor may further include mini-cores, and the processor may be configured to assign a differing quantity of mini-cores to the threads, based on an amount of calculation required by the threads, respectively.

The processor may be configured to operate in a very long instruction word (VLIW) mode and a coarse-grained reconfigurable array (CGRA) mode.

In response to the processor operating in the VLIW mode, the processor may be configured to operate in a power saving mode by halting an operation of remaining FUs, subsequent to excluding scalar FUs from the mini-core.

The processor may be configured to support an acceleration process through operating all FUs of the mini-core when the processor operates in the CGRA mode.

The processor may further include a central register file configured to transmit data between the VLIW mode and the CGRA mode.

In another general aspect, a processor includes mini-cores, wherein each of the mini-cores includes a scalar domain processor configured to process scalar data, a vector domain processor configured to process vector data, and a pack/unpack functional unit (FU) configured to process a conversion of data to be transmitted between the scalar domain processor and the vector domain processor.

The processor may be configured to allocate the mini-cores to threads, and to simultaneously execute the plurality of threads.

The processor may be configured to assign a differing quantity of mini-cores to the threads, based on an amount of calculation required by the threads, respectively.

The processor may suspend an operation of a portion of the mini-cores in order to save power, based on an amount of calculation to be processed by the processor.

The mini-cores may access single vector memories.

The processor may be configured to operate in a very long instruction word (VLIW) mode and a coarse-grained reconfigurable array (CGRA) mode.

The processor may be configured to operate in a power saving mode by halting an operation of remaining FUs, subsequent to excluding scalar FUs from among the mini-cores, when the processor operates in the VLIW mode.

Other features and aspects will be apparent from the following detailed description, the drawings, and the claims.

### BRIEF DESCRIPTION OF THE DRAWINGS

FIG. 1 is a diagram illustrating an example of a mini-core.

FIG. 2 is a diagram illustrating an example of a data path in the mini-core of FIG. 1.

FIG. 3 is a diagram illustrating an example of scalability of a mini-core.

FIG. 4 is a diagram illustrating an example of operation of the mini-core of FIG. 3 in a low power state.

FIG. 5 is a diagram illustrating an example of multi-thread execution.

FIG. 6 is a diagram illustrating an example of a plurality of vector FUs in a single mini-core.

FIG. 7 is a diagram illustrating an example of a plurality of vector FUs operating individually.

FIG. 8 is a diagram illustrating an example of an operation of two vector FUs connected to one another.

FIG. 9 is a diagram illustrating an example of an operation of four vector FUs connected to one another.

FIG. 10 is a diagram illustrating an example of a structure of a processor.

FIG. 11 is a diagram illustrating an example of a local register file.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

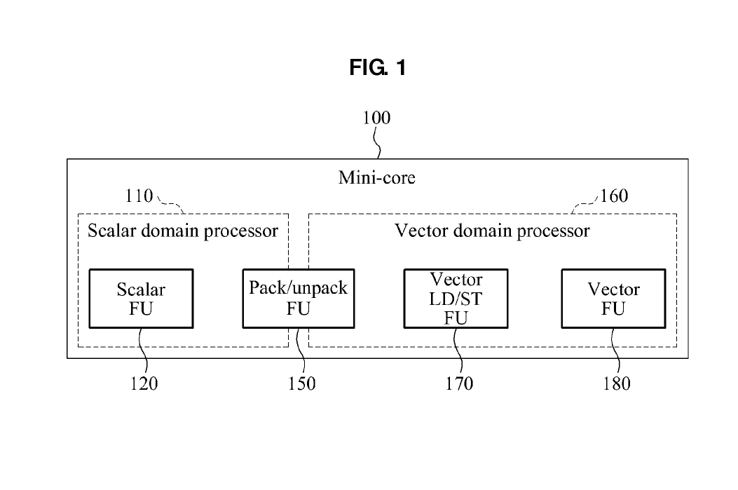

FIG. 1 illustrates an example of a mini-core 100.

In the example of FIG. 1, the mini-core 100 refers to a unit core configured by combining a plurality of functional units (FUs).

In such an example, the mini-core 100 includes a scalar domain processor 110 and a vector domain processor 160. The scalar domain processor 110 performs calculations associated with scalar data. The vector domain processor 160 performs calculations associated with vector data.

The scalar domain processor 110 includes an FU for calculation of the scalar data. For example, the scalar domain processor 110 includes a scalar FU 120 and a pack/unpack FU 150. The vector domain processor 160 includes an FU for calculation of the vector data. For example, the vector domain processor 160 includes the pack/unpack FU 150, a vector load (LD)/store (ST) FU 170, and a vector FU 180. In the example of FIG. 1, the mini-core 100 includes the scalar FU 120, the pack/unpack FU 150, the vector LD/ST FU 170, and the vector FU 180. A type and a number of the FUs described in the foregoing are examples. Other examples of the mini-core 100 include other FUs in addition to or in place of the previously mentioned FUs. Additionally, other examples include more than one instance of the scalar FU 120, the pack/unpack FU 150, the vector LD/ST FU 170, and the vector FU 180.

The scalar FU 120 processes a code or an instruction word associated with calculation and/or control of the scalar data. The code or the instruction word associated with the control for the scalar data refers to a code or an instruction word associated with a comparison calculation or a branch calculation. Also, the scalar FU 120 is able to process LD/ST operations for the scalar data. Additionally, the scalar FU 120 is able to process commonly used single-cycle instruction words.

In this example, the scalar data refers to data in a minimum calculation unit in which multiple data elements are not combined. In general, basic primitive data types including the following are referred to as potential types of the scalar data. First, a Boolean data type, for example, “true” and “false”. Second, numeric types, for example, “int”, “short int”, “float”, and “double”. Third, character types, for example, “char” and “string”.

In general, the scalar FU 120 uses a data path of a relatively low bit-size because the scalar FU 120 is provided for operating on a single data type.

The vector LD/ST FU 170 processes load data/store data (LD/ST) operations of the vector data. The vector LD/ST FU 170 loads data from a vector memory, and stores the data in the vector memory. Thus, the LD/ST of the vector data is performed in the vector LD/ST FU 170.

The vector FU 180 processes calculations of the vector data. The vector FU 180 processes calculations of the vector data, using a single instruction multiple data (SIMD) scheme. The calculations of the vector data include operations such as vector arithmetic, shift, multiplication, comparison, and data shuffling. The vector data calculations also include some instruction words for other vector operations such as vector demapping, which are potentially supported in a vector function unit (VFU) mode to be described later.

The SIMD scheme refers to a parallel processing scheme for simultaneously processing multiple data elements using a single instruction word. In this example, the SIMD refers to a scheme in which multiple calculation devices simultaneously apply a generally identical calculation, and simultaneously process multiple data elements as the operands for the generally identical calculations. For example, the SIMD is potentially used in a vector processor, because operating on vectors is a type of processing suitable for using a SIMD scheme.

Herein, the vector data refers to data including multiple scalar data elements that are all of an identical type. Thus, the vector data refers to data in a calculation unit in which multiple scalar data elements are merged for processing together.

For example, in OpenCL, a type of the vector data, such as “charn”, “ucharn”, “shortn”, “ushortn”, “intn”, “longn”, “ulongn”, and “floatn” is defined. “n” denotes a number of instances of the scalar data included in the vector data. A value of “n” may be greater than “2”, and in general, “2”, “4”, “8”, “16”, and other powers of 2 are used as the value of “n”.

The vector FU 180 requires a data path of a higher bit-size than that of the scalar FU 120 because the vector data refers to multiple data elements that are merged rather than consisting of a single data element, as in scalar data.

Thus, the vector FU 180 refers to a unit for processing multiple numbers of data in parallel. Accordingly, a size of the vector FU 180 is greater than a size of another FU, and occupies a larger proportion of area included in the area of the mini-core 100.

In the example of FIG. 1, the pack/unpack FU 150 processes a conversion of data to be transmitted and/or shared between the scalar domain processor 110 and the vector domain processor 160. In this example, the pack/unpack FU 150 refers to an FU common to the scalar domain processor 110 and the vector domain processor 160. Alternatively, the pack/unpack FU 150 is shared between the scalar domain processor 110 and the vector domain processor 160 using another structure that allows both the scalar domain processor 110 and the vector domain processor 160 to access the pack/unpack FU 150.

The pack/unpack FU 150 converts the multiple instances of scalar data into the vector data. The pack/unpack FU 150 generates the vector data by merging the multiple instances of scalar data. Alternatively, the pack/unpack FU 150 inserts the scalar data instances into predetermined positions of the vector data, and generates or updates the vector data appropriately.

The pack/unpack FU 150 converts the vector data to a single or multiple instances of scalar data. The pack/unpack FU 150 divides the vector data, and thereby generates the multiple instances of scalar data. Alternatively, the pack/unpack FU 150 extracts an element from a predetermined position or a slot of the vector data to generate the scalar data. In an example, a particular element of the vector data refers to an instance of the scalar data.

In a particular example, the pack/unpack FU 150 is disposed in a middle region between the scalar domain processor 110 and the vector domain processor 160. In such an example, the pack/unpack FU 150 functions as a bridge between the scalar domain processor 110 and the vector domain processor 160. An exchange of data between the scalar domain processor 110 and the vector domain processor 160 is performed subsequent to a type conversion of data by the pack/unpack FU 150.

Through combined utilization of the aforementioned FUs, the mini-core 100 processes all of the instruction words that are to be processed in a processor. Accordingly, even if only a single mini-core 100 exists and if only a single mini-core 100 is operative in the processor, the processor is still able to operate and perform all of its functionality.

As described in the foregoing example, an FU is divided into core FUs, such as the scalar FU 120, the pack/unpack FU 150, the vector LD/ST FU 170, and the vector FU 180, and the core FUs are elements included in the configuration of the mini-core 100. Thus, the logic included in the processor is simplified through expanding the mini-core 100 as discussed, rather than simply providing a random or arbitrary combination of various FUs. Also, through the expansion of the mini-core 100 as discussed, a number of designs possible to be created in a design space exploration (DSE) are reduced to a great extent.

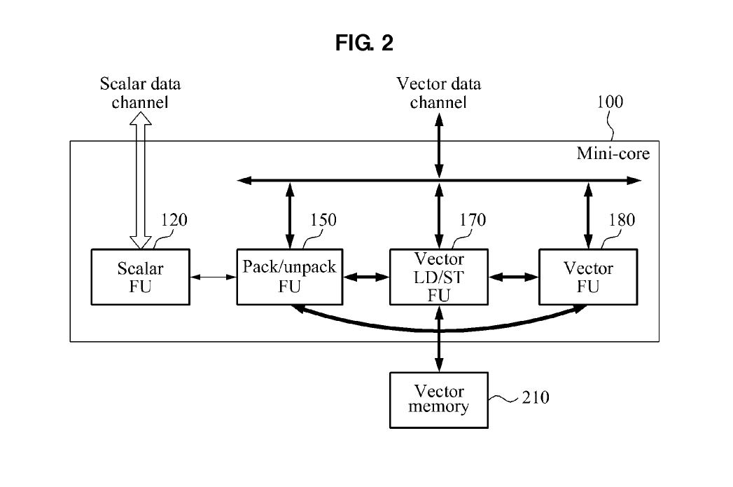

FIG. 2 illustrates an example of a data path in the mini-core 100.

In the example of FIG. 2, a data path exists among FUs of the scalar domain processor 110. In this example, the mini-core 100 includes a data path between the scalar FU 120 and the pack/unpack FU 150. Such a data path allows the scalar FU 120 to direct data to and from the pack/unpack FU 150 to share data between the scalar domain processor 110 and the vector domain processor 160.

In the example of FIG. 2, a data path exists between FUs of the vector domain processor 160. For example, the mini-core 100 includes a data path between each pair of two FUs from among the pack/unpack FU 150, the vector LD/ST FU 170, and the vector FU 180.

A data path directly linking together the scalar domain processor 110 and the vector domain processor 160 does not exist in this example, aside from the pack/unpack FU 150. In particular, data transfer between the scalar domain processor 110 and the vector domain 160 is performed subsequent to a type conversion by the pack/unpack FU 150. For example, the type conversion includes conversion of the scalar data to the vector data and includes conversion of the vector data to the scalar data, so that the scalar domain processor 110 and the vector domain 160 are supplied with data that is suitable for the type of specialized processing that occurs in a particular domain.

FUs in an identical domain potentially have full data interconnection. An area of a data path varies based on the nature of a particular one of a plurality of domains to which it applies.

In one case, in a particular example, a value of a memory address for a LD or ST operation calculated in the scalar FU 120 is transferred to the vector LD/ST FU 170. The mini-core 100 potentially includes a data path for transferring the memory address for the LD or ST operation from the scalar FU 120 to the vector LD/ST FU 170. Here, the data path for transferring the memory address refers to a relatively narrow data path. Such a path only needs to transfer a memory address, which is a relatively small amount of information. A data path for transferring data to be described further later refer to a relatively wide data path, as transferring data requires the ability to transfer a larger amount of data.

In the example of FIG. 2, two types of channels exist for transferring data between mini-cores. The two types of channels shown are a scalar data channel and a vector data channel.

The mini-core 100 transmits the scalar data to another mini-core via the scalar data channel, and receives the scalar data from the other mini-core via the scalar data channel. In such an example, the scalar data channel is linked to an FU of the scalar domain processor 110.

The mini-core 100 transmits the vector data to another mini-core via the vector data channel, and receives the vector data from the other mini-core via the vector data channel. In such an example, the vector data channel is linked to an FU of the vector domain 160.

In an example, the mini-core 100 has scalar data channels in a quantity that correspond to a number of other mini-cores for transfer of the scalar data with the other mini-cores. Thus, the mini-core 100 has a single scalar data channel providing for the transfer of the scalar data with each other mini-core that it shares scalar data with. The scalar data channels are linked to the other mini-cores, respectively. In an alternative case, the mini-core 100 has scalar data channels in a quantity that is greater than a number of the other mini-cores. The mini-core 100 exchanges the scalar data, in such a case, with at least one of the other mini-cores via a plurality of scalar data channels.

Also in this example, the mini-core 100 has vector data channels in a quantity that corresponds to a number of other mini-cores for transfer of the vector data with the other mini-cores, respectively. The vector data channels are connected to the other mini-cores, respectively. In an alternative case, the mini-core 100 has vector data channels in a quantity that is greater than a number of the other mini-cores, providing for a multi-path architecture. The mini-core 100 exchanges the vector data, in such a case, with at least one of the other mini-cores via a plurality of vector data channels.

Through the configuration of the data channels described above, data paths between FUs for which direct connection is not required are excluded from a mini-core and a processor. In particular, the interconnection in the mini-core 100 or the processor is minimized by removing an unnecessary data path from among the data paths between FUs. For example, the unnecessary data path refers to a data path between the scalar FU 120 and the vector FU 180.

Data transfer among the mini-cores is simplified by providing a scalar data channel and a vector data channel to the mini-core 100. By providing a separate scalar data channel and a vector data channel when transferring data, it is possible to provide the capability to handle different types of data processing adequately while still simplifying design requirements.

In the example of FIG. 2, the mini-core 100 further includes a vector memory 210. In such an example, the vector memory 210 refers to a memory dedicated to being used by the vector LD/ST FU 170. The mini-core 100 further includes an access port to be used for the vector LD/ST FU 170 to access the vector memory 210. In this example, the vector memory 210 is not shared with other FUs other than the vector LD/ST FU 170, which accesses the vector memory 210 through the access port. A number of ports included in the mini-core 100 is reduced by not sharing the vector memory 210, and an access logic associated with an access to the vector memory 210 is also simplified. The reduction of the number of ports and the simplification of the access logic potentially leads to benefits in terms of power consumed by the processor and an area of the mini-core 100.

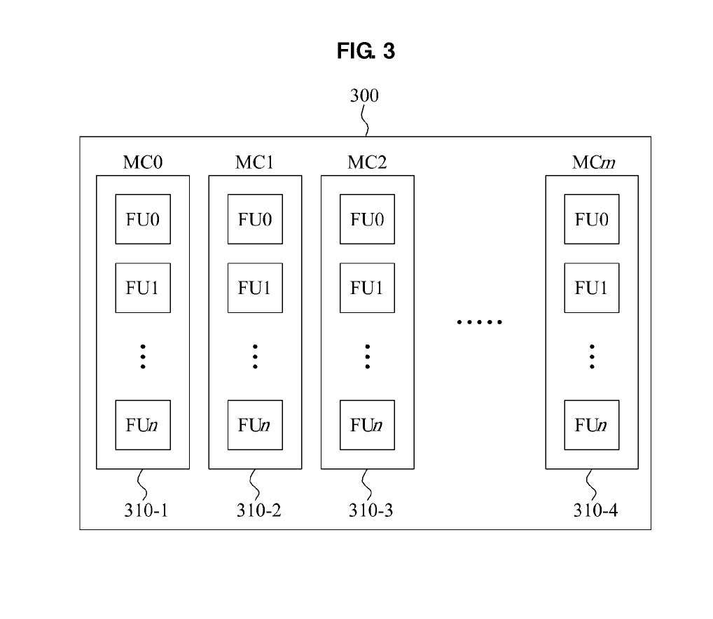

FIG. 3 illustrates an example of scalability of a mini-core.

According to examples, a processor 300 includes at least one mini-core.

In the example of FIG. 3, the at least one mini-core refers to the mini-core 100 described with reference to FIG. 1. In FIG. 3, an MC0 310-1, an MC1 310-2, an MC2 310-3, and an MCm 310-4 are illustrated as the at least one mini-core. The MC0 310-1, the MC1 310-2, the MC2 310-3, and the MCm 310-4 each refer to a particular example of the mini-core 100, respectively. In particular, the processor 300 is illustrated to include an “m+1” number of such mini-cores in FIG. 3.

In the respective mini-cores, FUs for the mini-cores are illustrated. In FIG. 3, the FUs of the respective mini-cores are represented as FU0, FU1, and FUn for each of the mini-cores. In the illustrated example, the respective mini-cores each include an “n+1” number of FUs. In such an example, the FUs included in the mini-cores are each designated as one of the scalar FU 120, the pack/unpack FU 150, the vector LD/ST FU 170, and the vector FU 180.

Alternatively, a first mini-core refers to the mini-core 100 described with reference to FIG. 1 from among the at least one mini-core provided in FIG. 3.

As described with reference to FIG. 1, a single mini-core 100 is designed to process all instruction words to be processed in the processor 300. When an application is executed in the processor 300, an amount of calculation required by the application differs based on characteristics of the application. The processor design 300 is potentially designed based upon the amount of calculation required by the application through use of the single mini-core 100 with respect to a simple application. In an example, a number of mini-cores 100 to be used is adjusted, by the processor 300, to correspond to a amount of calculation required with respect to an application that requires a greater amount of calculation.

The design of the processor 300 is facilitated by expanding and/or managing the use of mini-cores that are efficiently configured, as discussed above.

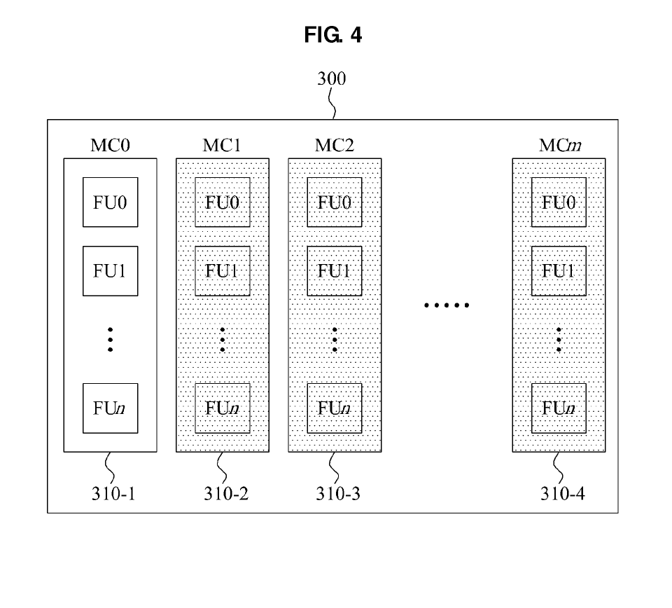

FIG. 4 illustrates an example of a control of the mini-core of FIG. 3 in a low power state.

In the example of FIG. 4, the processor 300 suspends an operation of a portion or total of selected mini-cores from among at least one mini-core. By way of example, in FIG. 4, other than the mini-core MC0 310-1, operations of the remaining mini-cores, such as the MC1 310-2, the MC2 310-3, and the MCm 310-4 are illustrated as being suspended.

When the processor 300 executes an application that involves a relatively small amount of calculation and/or requires a relatively small amount of processing resources, in an example the processor 300 suspends a portion of operations from among the at least one mini-core.

For example, the processor 300 suspends an operation of a first mini-core from among the at least one mini-core, based on an amount of calculation to be processed by the processor 300. Here, the first mini-core refers to the mini-core 100 described with reference to FIG. 1. The processor 300 blocks a clock to be provided to the first mini-core, and by doing so suspends the operation of the first mini-core. Alternatively, the processor 300 blocks power of the first mini-core, and by doing so suspends the operation of the first mini-core. For example, the processor 300 reduces power consumption of the first mini-core through clock gating or power gating. Therefore, by blocking of the aforementioned clock or power, a low power mode of the processor 300 is implemented, because without receipt of a clock or power, the processor 300 does not consume as much power.

By contrast, the processor 300 activates all available mini-cores, and executes an application by using all mini-cores in a situation when an application requiring a large amount of calculation is executed.

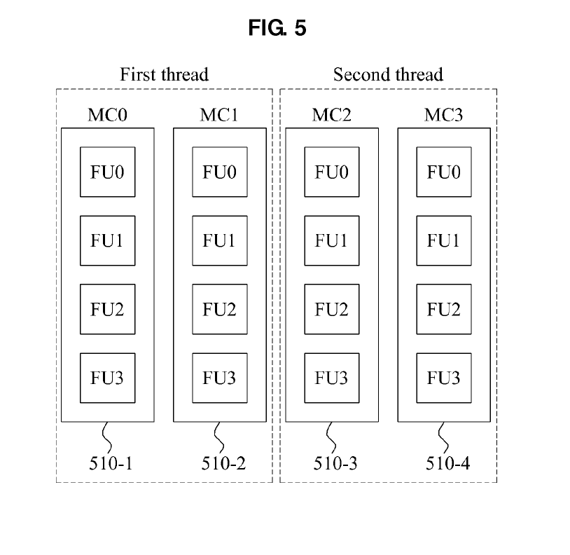

FIG. 5 illustrates an example of a multi-thread execution.

In the example of FIG. 5, the processor 300 executes a plurality of threads. In such an example, the processor 300 assigns at least one mini-core to a single thread from among the plurality of threads, respectively. The processor 300 simultaneously executes the plurality of threads by allocating the at least one mini-core to the plurality of threads, respectively.

In FIG. 5, an MC0 510-1, an MC1 510-2, an MC2 510-3, and an MC3 510-4 are illustrated as examples corresponding to the at least one mini-core. In this example, the MC0 510-1, the MC1 510-2, the MC2 510-3, and the MC3 510-4 refer to instances of the mini-core 100, respectively.

In the example of FIG. 5, the MC0 510-1 and the MC1 510-2 are assigned to a first thread, and the MC2 510-3 and the MC3 510-4 are assigned to a second thread.

In the example of FIG. 5, a quantity of mini-cores to be assigned potentially corresponds to a number of the plurality of threads. In an example, the processor 300 potentially assigns mini-cores in different quantities to the plurality of threads, respectively. In a particular example, the processor 300 optionally assigns a greater quantity of mini-cores to a thread requiring a greater amount of calculation. The processor 300 assigns mini-cores in this manner in order to increase efficiency and performance.

Also, the processor 300 simultaneously executes a number of threads corresponding to a quantity of the at least one mini-core, and assigns the at least one mini-core to the plurality of threads.

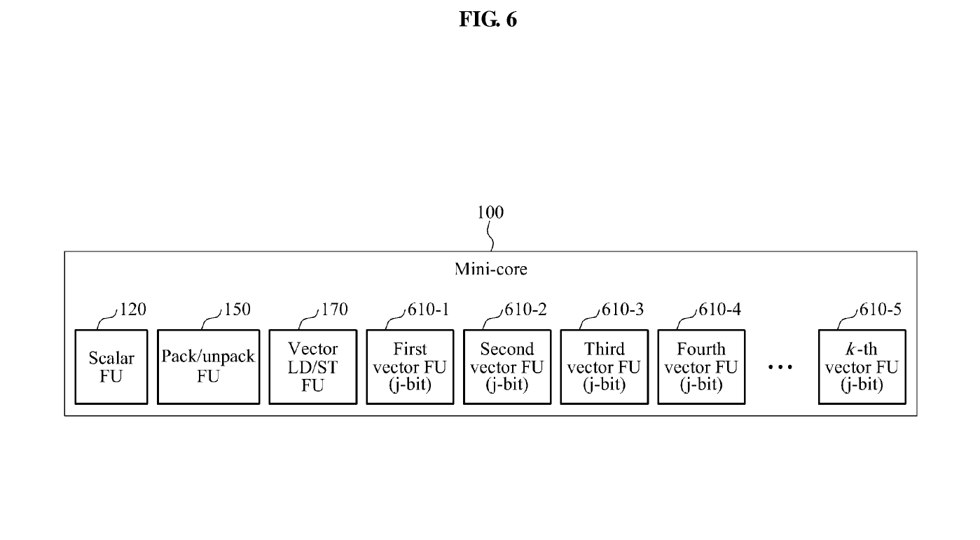

FIG. 6 illustrates an example of a plurality of vector FUs in a single mini-core.

In the example of FIG. 6, multiple instances of the vector FU 180 described with reference to FIG. 1 are provided. Thus, the mini-core 100 includes a plurality of vector FUs. In the example of FIG. 6, a first vector FU 610-1, a second vector FU 610-2, a third vector FU 610-3, a fourth vector FU 610-4, and a k-th vector FU 610-5 are illustrated as the plurality of vector FUs. The first vector FU 610-1, the second vector FU 610-2, the third vector FU 610-3, the fourth vector FU 610-4, and the k-th vector FU 610-5 correspond to the vector FU 180, respectively.

In FIG. 6, the plurality of vector FUs process calculation of vector data of a j-bit size, respectively. Here, “j” is an integer greater than “1”. “k” may be a number of the plurality of vector FUs. Here, “k” is an integer greater than “2”.

In FIG. 6, the plurality of vector FUs are interconnected and operate in order to process vector data of a bit-length greater than a bit-length that is able to be processed by the plurality of vector FUs.

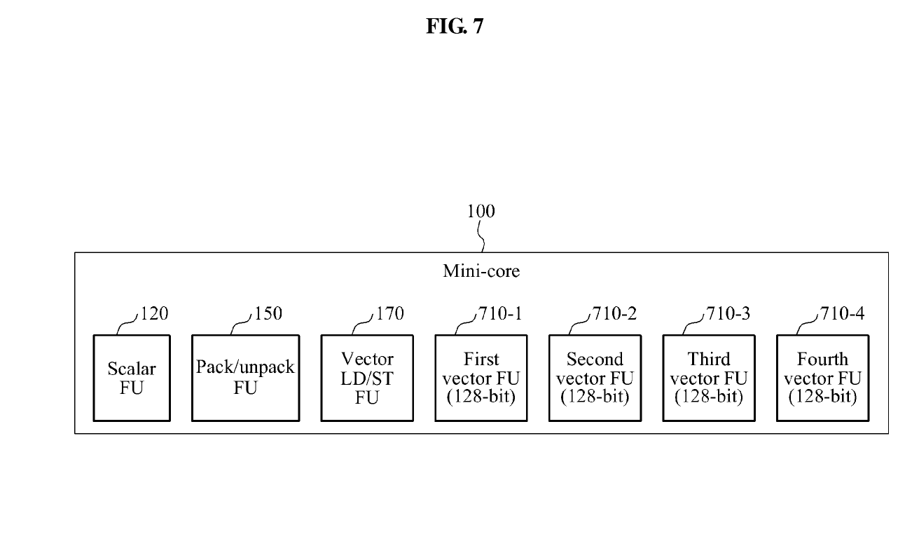

FIG. 7 illustrates an example of a plurality of vector FUs operating individually.

In FIG. 7, a first vector FU 710-1, a second vector FU 710-2, a third vector FU 710-3, and a fourth vector FU 710-4 are illustrated as corresponding to the plurality of vector FUs. The first vector FU 710-1, the second vector FU 710-2, the third vector FU 710-3, and the fourth vector FU 710-4 refer to the vector FU 180, respectively.

In FIG. 7, the four vector FUs are illustrated as being able to process calculation of 128 bit vector data, respectively. In this particular example, a value of “k” is “4”, and a value of “j” is 128.

In FIG. 7, four vectors of 128-bit are operated upon individually.

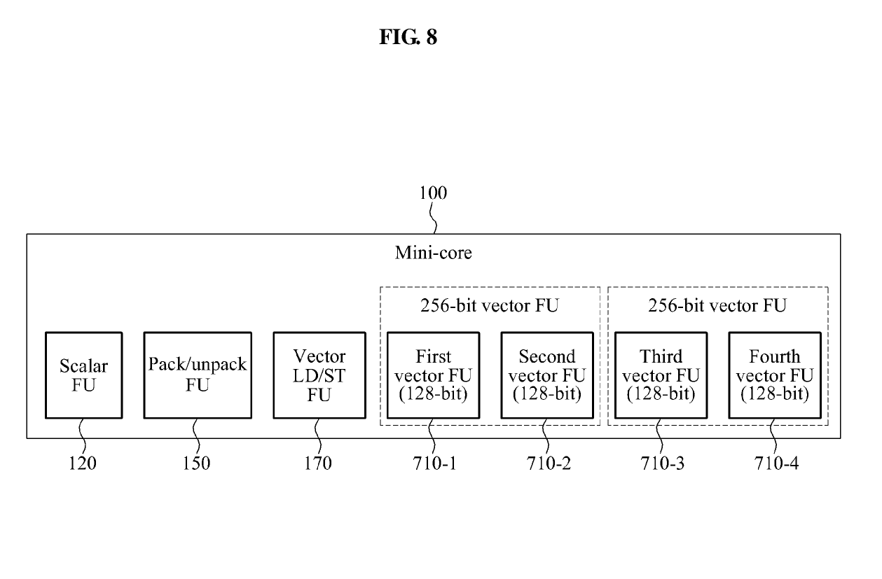

FIG. 8 illustrates an example of an operation of two vector FUs connected to one another.

In the example of FIG. 8, the first vector FU 710-1 and the second vector FU 710-2 connected to one another operate as a single vector FU with a 256-bit data size. Also, the third vector FU 710-3 and the fourth vector FU 710-4 connected to one another operate as another vector FU with a 256-bit data size.

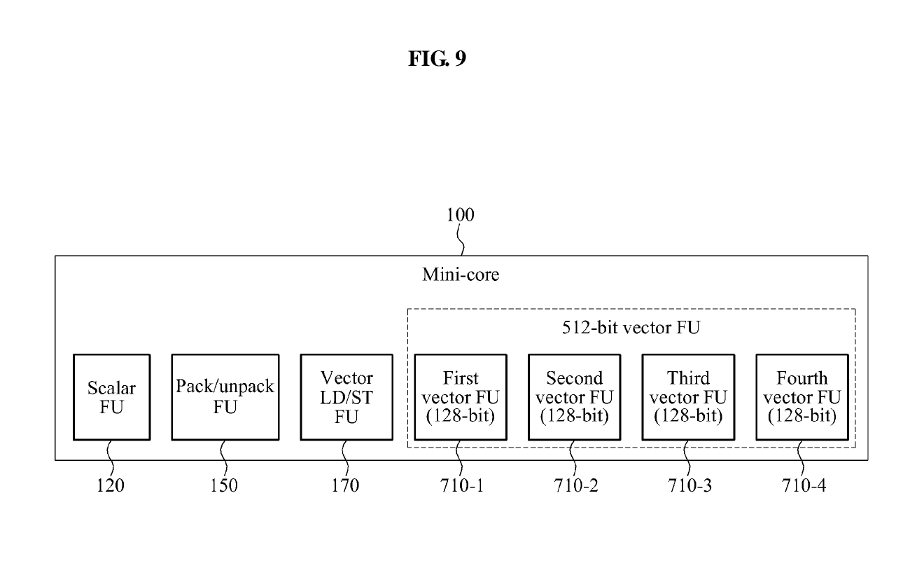

FIG. 9 illustrates an example of an operation of four vector FUs connected to one another.

In FIG. 9, the first vector FU 710-1, the second vector FU 710-2, the third vector FU 710-3, and the fourth vector FU 710-4 connected to one another operate as a single vector FU with a 512-bit data size.

As described with reference to FIGS. 7 through 9, the processor 300 dynamically reconfigure a plurality of vector FUs, and provide an SIMD process of various bit-areas by connecting and reconfiguring the vector FUs to adapt the vector FUs to handle data of different sizes.

The processor 300 provides a plurality of data level parallelism (DLP) based on an application to be executed in a processor through use of a plurality of vector FUs. DLP is achieved in SIMD by performing the same task on different pieces of distributed data. Based on a characteristic of an application, processing a predetermined application through use of a wide SIMD is potentially inefficient, if the application does not require the full width. Because of this issue, in an example the processor 300 divides processing of an application into multiple vector FUs having a narrower bit-area with respect to an application that does not fully use the wide SIMD.

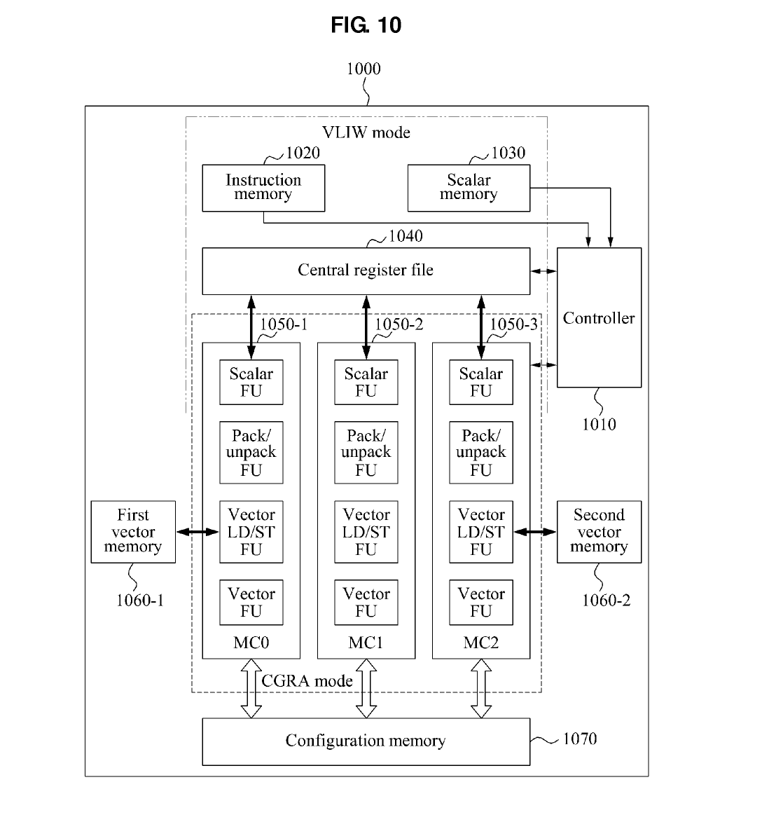

FIG. 10 illustrates an example of a structure of a processor 1000.

In the example of FIG. 10, the processor 1000 corresponds to the processor 300 described with respect to FIG. 3. Descriptions of the processor 300 provided above apply to the processor 1000 and thus, repeated descriptions are omitted here for brevity.

For example, the processor 1000 includes a controller 1010, an instruction memory 1020, a scalar memory 1030, a central register file 1040, a plurality of mini-cores, a plurality of vector memories, and a configuration memory 1070.

In FIG. 10, an MC0 1050-1, an MC1 1050-2, and an MC2 1050-3 are illustrated as an example of a plurality of mini-cores. The MC0 1050-1, the MC1 1050-2, and the MC2 1050-3 refer to instances of the mini-core 100, respectively. A first vector memory 1060-1 and a second vector memory 1060-2 are illustrated as examples of the plurality of vector memories.

The controller 1010 controls configurations of the processor 1000. For example, the controller 1010 controls a plurality of mini-cores. The controller 1010 suspends an operation of a portion or all mini-cores from among at least one mini-core, as discussed above. The controller 1010 executes a function of the processor 300, as described, associated with an operation of a mini-core, execution of a thread, and interconnection of a plurality of vector FUs.

In the example of FIG. 10, the instruction memory 1020 and the configuration memory 1070 store instruction words to be executed by the processor 1000 or the mini-core.

The scalar memory 1030 stores scalar data.

The central register file 1040 stores registers.

For example, the processor 1000 operates in a VLIW mode and a CGRA mode. In the VLIW mode, the processor 1000 processes the scalar data, or performs control operation. In the CGRA mode, the processor 1000 processes operation of a loop, and the like, in code in which acceleration and/or parallel processing is required. Here, the loop potentially refers to a retractable loop. An operation in the loop potentially uses heavy vector processing. In such an example, instruction words associated with control are available in the VLIW mode only, and vector instruction words are available in the CGRA mode only. Such strict separation of the instruction words between the two modes further simplifies design of the processor 1000, or enhances power efficiency.

In the VLIW mode, the instruction words are fetched from the instruction memory 1020. The fetched instruction words are executed by scalar FUs of a plurality of mini-cores. In the CGRA mode, the instruction words are fetched from the configuration memory 1070. The fetched instruction words are executed by all FUs of the plurality of mini-cores.

The scalar FU from among the plurality of mini-cores is used in both the VLIW mode and the CGRA mode. In particular, the scalar FU is shared in the VLIW mode and the CGRA mode. In the example of FIG. 10, the processor 1000 simultaneously operates three scalar FUs from among FUs of the plurality of mini-cores when operating in the VLIW mode.

When an operation mode of the processor 1000 is converted from the VLIW mode to the CGRA mode, the processor 1000 is able to operate all FUs of the plurality of mini-cores. For example, when the processor 100 operates in the CGRA mode, the processor 1000 is configured to support accelerated processing by operating all FUs of the plurality of mini-cores.

Accordingly, when the processor 1000 operates in the VLIW mode, the processor 1000 operates in a power saving mode through suspending an unnecessary operation of remaining FUs, aside from the scalar FUs from among FUs of the plurality of mini-cores. Here, the remaining FUs potentially include a pack/unpack FU, a vector LD/ST FU, and a vector FU, as discussed above. Because these FUs are adapted for use in vector processing, the VLIW mode does not use them and hence it is suitable to suspend their operation. Also, the processor 1000 converts an operation mode rapidly through transmitting parameters required between the two modes via common FUs, and a step of copying data between the VLIW mode and the CGRA mode is avoided.

Scalar FUs from among the plurality of mini-cores access the central register file 1040. A wide register file is avoided by limiting access to the central register file 1040 to the scalar FUs, which have a narrower data width than the vector FUs. Alternatively, the plurality of mini-cores perform read access with respect to the central register file 1040, respectively, and the scalar FUs from among the plurality of mini-cores are able to access the retrieved information received with respect to the central register file 1040.

The plurality of mini-cores each uses a single vector memory from among a plurality of vector memories. Alternatively, the plurality of mini-cores each includes a single vector memory from among the plurality of vector memories. In the example of FIG. 10, the MC0 1050-1 uses the first vector memory 1060-1. The MC2 1050-3 uses the second vector memory 1060-2.

Use of a complex structure for sharing a vector memory, such as a queue, is avoided by providing separate vector memories to the plurality of mini-cores, respectively. In particular, a memory access logic is simplified by providing a memory to the plurality of mini-cores, respectively. Excluding the complex structure simplifies design of the processor 1000, and benefits the processor 1000 in terms of power usage and area.

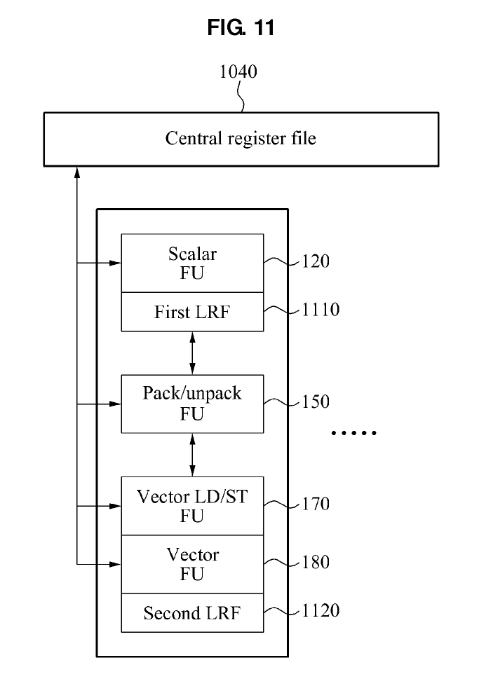

FIG. 11 illustrates an example of a local register file.

For example, the processor 1000 of FIG. 10 provides two types of register files. The central register file 1040 described with reference to FIG. 10 is used for primary transmission of data between the VLIW mode and the CGRA mode. For example, live-in variables and live-out variables in the CGRA mode potentially remain in the central register file 1040. A variable is live if it holds a value that is potentially needed in the future. For example, live variables are potentially read before the next time that they are written.

In the example of FIG. 11, the mini-core 100 further includes a first local register file (LRF) 1110 for the scalar FU 120 and a second local register file (LFR) 1120 for the vector FU 180. The first local data register file 1110 temporarily stores the scalar data until the scalar FU 120 requires the scalar data, after a plurality of cycles have passed. The second local data register file 1120 temporarily stores the vector data until the vector FU 180 requires the vector data, after a plurality of cycles have passed.

In the mini-core 100, for example, a combination of multiple FUs, are configured as per examples described in the foregoing. A structure of a data path for interconnecting FUs is minimized in such a mini-core 100. A processor thus has scalability to readily correspond to an amount of calculation required, by adjusting a number of active mini-cores.

Extensive use of the mini-core 100 and the processor according to examples are potentially made in a multimedia field, a communication field, or another field in which a DLP approach is used.

The apparatuses and units described herein may be implemented using hardware components. The hardware components may include, for example, controllers, sensors, processors, generators, drivers, and other equivalent electronic components. The hardware components may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The hardware components may run an operating system (OS) and one or more software applications that run on the OS. The hardware components also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, a hardware component may include multiple processors or a processor and a controller. In addition, different processing configurations are possible, such as parallel processors.

The methods described above can be written as a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device that is capable of providing instructions or data to or being interpreted by the processing device. The software also may be distributed over network coupled computer systems so that the software is stored and executed in a distributed fashion. In particular, the software and data may be stored by one or more non-transitory computer readable recording mediums. The media may also include, alone or in combination with the software program instructions, data files, data structures, and the like. The non-transitory computer readable recording medium may include any data storage device that can store data that can be thereafter read by a computer system or processing device. Examples of the non-transitory computer readable recording medium include read-only memory (ROM), random-access memory (RAM), Compact Disc Read-only Memory (CD-ROMs), magnetic tapes, USBs, floppy disks, hard disks, optical recording media (e.g., CD-ROMs, or DVDs), and PC interfaces (e.g., PCI, PCI-express, WiFi, etc.). In addition, functional programs, codes, and code segments for accomplishing the example disclosed herein can be construed by programmers skilled in the art based on the flow diagrams and block diagrams of the figures and their corresponding descriptions as provided herein.

As a non-exhaustive illustration only, a terminal/device/unit described herein may refer to mobile devices such as, for example, a cellular phone, a smart phone, a wearable smart device (such as, for example, a ring, a watch, a pair of glasses, a bracelet, an ankle bracket, a belt, a necklace, an earring, a headband, a helmet, a device embedded in the cloths or the like), a personal computer (PC), a tablet personal computer (tablet), a phablet, a personal digital assistant (PDA), a digital camera, a portable game console, an MP3 player, a portable/personal multimedia player (PMP), a handheld e-book, an ultra mobile personal computer (UMPC), a portable lab-top PC, a global positioning system (GPS) navigation, and devices such as a high definition television (HDTV), an optical disc player, a DVD player, a Blu-ray player, a setup box, or any other device capable of wireless communication or network communication consistent with that disclosed herein. In a non-exhaustive example, the wearable device may be self-mountable on the body of the user, such as, for example, the glasses or the bracelet. In another non-exhaustive example, the wearable device may be mounted on the body of the user through an attaching device, such as, for example, attaching a smart phone or a tablet to the arm of a user using an armband, or hanging the wearable device around the neck of a user using a lanyard.

A computing system or a computer may include a microprocessor that is electrically connected to a bus, a user interface, and a memory controller, and may further include a flash memory device. The flash memory device may store N-bit data via the memory controller. The N-bit data may be data that has been processed and/or is to be processed by the microprocessor, and N may be an integer equal to or greater than 1. If the computing system or computer is a mobile device, a battery may be provided to supply power to operate the computing system or computer. It will be apparent to one of ordinary skill in the art that the computing system or computer may further include an application chipset, a camera image processor, a mobile Dynamic Random Access Memory (DRAM), and any other device known to one of ordinary skill in the art to be included in a computing system or computer. The memory controller and the flash memory device may constitute a solid-state drive or disk (SSD) that uses a non-volatile memory to store data.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A mini-core comprising:
a scalar domain processor configured to process scalar data;
a vector domain processor configured to process vector data; and
a pack/unpack functional unit (FU) configured to be shared by the scalar domain processor and the vector domain processor, and to process a conversion of data to be transmitted between the scalar domain processor and the vector domain processor.

2. The mini-core of claim 1, wherein the scalar domain processor comprises a scalar FU configured to process scalar data.

3. The mini-core of claim 1, wherein the pack/unpack FU is configured to convert multiple instances of scalar data to an instance of vector data, and to generate an instance of scalar data by extracting an element at a predetermined position of the vector data.

4. The mini-core of claim 1, wherein the vector domain processor comprises:
a vector load (LD)/store (ST) FU configured to process loading and storing of vector data; and
a vector FU configured to process the vector data.

5. The mini-core of claim 4, wherein the vector domain processor comprises vector FUs and the vector domain processor operates by interconnecting the vector FUs to process vector data of a longer bit length than a bit-length processable by the vector FUs individually.

6. The mini-core of claim 4, wherein the vector domain processor further comprises:
a vector memory configured to store the vector data.

7. The mini-core of claim 1, wherein the mini-core transmits the scalar data to another mini-core via a scalar data channel, and
the mini-core transmits the vector data to the other mini-core via a vector data channel.

8. A mini-core comprising vector functional units (FUs) configured to process a calculation of vector data,
wherein the vector FUs operate by being interconnected to one another to process vector data of a longer bit-length than a bit-length processable by the vector FUs individually.

9. The mini-core of claim 8, wherein the mini-core further comprises:
a scalar domain processor configured to process scalar data;
a vector domain processor configured to process vector data; and
a pack/unpack functional unit (FU) configured to be shared by the scalar domain processor and the vector domain processor, and to process a conversion of data to be transmitted between the scalar domain processor and the vector domain processor,
wherein the vector domain processor comprises the vector FUs.

10. A processor comprising a mini-core, wherein the mini-core comprises:
a scalar domain processor configured to process scalar data;
a vector domain processor configured to process vector data; and
a pack/unpack functional unit (FU) configured to process a conversion of data to be transmitted between the scalar domain processor and the vector domain processor.

11. The processor of claim 10, wherein the processor is configured to halt an operation of the mini-core, based on an amount of calculation to be processed by the processor.

12. The processor of claim 11, wherein the processor is configured to halt an operation of the mini-core by blocking a clock provided to the mini-core, or by blocking power to the mini-core.

13. The processor of claim 10, wherein the processor is configured to assign the mini-core to threads, and to simultaneously execute the threads.

14. The processor of claim 13, wherein the processor further comprises mini-cores, and the processor is configured to assign a differing quantity of mini-cores to the threads, based on an amount of calculation required by the threads, respectively.

15. The processor of claim 10, wherein the processor is configured to operate in a very long instruction word (VLIW) mode and a coarse-grained reconfigurable array (CGRA) mode.

16. The processor of claim 15, wherein, in response to the processor operating in the VLIW mode, the processor is configured to operate in a power saving mode by halting an operation of remaining FUs, subsequent to excluding scalar FUs from the mini-core.

17. The processor of claim 15, wherein the processor is configured to support an acceleration process through operating all FUs of the mini-core when the processor operates in the CGRA mode.

18. The processor of claim 15, wherein the processor further comprises:
a central register file configured to transmit data between the VLIW mode and the CGRA mode.

19. A processor comprising mini-cores, wherein each of the mini-cores comprises:
a scalar domain processor configured to process scalar data;
a vector domain processor configured to process vector data; and
a pack/unpack functional unit (FU) configured to process a conversion of data to be transmitted between the scalar domain processor and the vector domain processor.

20. The processor of claim 19, wherein the processor is configured to allocate the mini-cores to threads, and to simultaneously execute the plurality of threads.

21. The processor of claim 20, wherein the processor is configured to assign a differing quantity of mini-cores to the threads, based on an amount of calculation required by the threads, respectively.

22. The processor of claim 19, wherein the processor suspends an operation of a portion of the mini-cores in order to save power, based on an amount of calculation to be processed by the processor.

23. The processor of claim 19, wherein the mini-cores access single vector memories.

24. The processor of claim 19, wherein the processor is configured to operate in a very long instruction word (VLIW) mode and a coarse-grained reconfigurable array (CGRA) mode.

25. The processor of claim 24, wherein the processor is configured to operate in a power saving mode by halting an operation of remaining FUs, subsequent to excluding scalar FUs from among the mini-cores, when the processor operates in the VLIW mode.
